(19) United States
(12) Patent Application Publication
(10) Pub. No.: US 2006/0170903 A1
(43) Pub. Date: Aug. 3, 2006

(54) Rangefinder

(75) Inventors: Shimon Aburmad, Nahariya (IL); Ehud Chishinski, Nofit (IL); Thomas Langer, Kfar Vradim (IL)

Correspondence Address: DR. MARK FRIEDMAN LTD.;C/O Bill Polkinghorn, 9003 Florin Way, Upper Marlboro, MD, 20772, US

(73) Assignee: RAFAEL-ARMAMENT DEVELOPMENT AUTHORITY LTD.

(21) Appl. No.: 11/337,535

(22) Filed: Jan. 24, 2006

(30) Foreign Application Priority Data
Jan. 30, 2005 (IL) 166575

(51) Int. Cl. G01C 3/08

(52) U.S. Cl. 356/5.06; 356/5.01

(57) ABSTRACT

A range finder system for determining a range of an object. The system includes a source of laser radiation configured for transmitting a plurality of pulses, a first detector, a second detector, an optical arrangement configured for directing the pulses along an outgoing path and receiving the pulses reflected by the object along a return path. The first detector is deployed to be responsive to the pulses traveling along the outgoing path and the second detector insensitive to the reflections of the pulses from less that the minimum range. The system further includes a controller configured for shorting a connection within the second detector to make the second detector insensitive to the reflections of the pulses from less than a minimum range, and for determining the range of the object based upon a time-of-flight of one or more of the pulses based upon output signals of the first detector and the second detector.

### FIELD AND BACKGROUND OF THE INVENTION

The present invention relates to rangefinders and, in particular, it concerns rangefinders for use in a guided missile.

By way of introduction, rangefinders are typically installed behind a window of a missile seeker head. The window is generally formed from a heat resistant material such as sapphire. Additionally, it is advantageous for the laser and detector of the range finder to share the same optical channel in order to make the rangefinder compact. However, up to 10% of the outgoing laser pulses are reflected back by the seeker head window to the detector. These reflections can destroy the detector or at the very least saturate the sensor.

Additionally, back-scattering from atmospheric aerosols can saturate the sensor and/or distort the range computations of the rangefinder.

There is therefore a need for an accurate rangefinder which prevents the detector from being saturated or destroyed by reflections from the missile window or aerosols.

### SUMMARY OF THE INVENTION

The present invention is a rangefinder construction and method of operation thereof.

According to the teachings of the present invention there is provided, a range finder system for determining a range of an object, comprising: (a) a source of laser radiation configured for transmitting a plurality of pulses; (b) a first detector; (c) a second detector; (d) an optical arrangement configured for directing the pulses along an outgoing path and receiving the pulses reflected by the object along a return path, wherein: (i) the first detector is deployed to be responsive to the pulses traveling along the outgoing path; and (ii) the second detector is deployed to detect the pulses traveling along the return path; and (e) a controller configured for: (i) shorting a connection within the second detector so as to render the second detector insensitive to the reflections of the pulses from less than a minimum range; and (ii) determining the range of the object based upon a time-of-flight of at least one of the pulses based upon output signals of the first detector and the second detector.

In accordance with an additional feature of the present invention, the controller is configured for shorting the connection within the second detector for at least 20 nanoseconds.

In accordance with an additional feature of the present invention, there is also provided a shared electronic channel having a channel input and a channel output, the shared electronic channel being configured for amplifying signals, wherein the first detector has a first detector output operationally connected to the channel input and the second detector has a second detector output operationally connected to the channel input, wherein the controller is operationally connected to the channel output.

In accordance with an additional feature of the present invention, the shared electronic channel is also configured for filtering signals.

In accordance with an additional feature of the present invention, there is also provided a switch having a first switch input, a second switch input and a switch output, the first switch input being electrically connected to the switch output in a first operative position of the switch, the second switch input being electrically connected to the switch output in a second operative position of the switch, the first detector output being electrically connected to the first switch input, the second detector output being electrically connected to the second switch input, the switch output being electrically connected to the channel input.

In accordance with the teachings of the present invention, there is a range finder system for determining a range of an object, comprising: (a) a source of laser radiation configured for transmitting a plurality of pulses; (b) a first detector; (c) a second detector; (d) an optical arrangement configured for directing the pulses along an outgoing path and receiving the pulses reflected by the object along a return path, wherein: (i) the first detector is deployed to be responsive to the pulses traveling along the outgoing path; and (ii) the second detector is deployed to detect the pulses traveling along the return path; (e) a shared electronic channel having a channel input and a channel output, the shared electronic channel being configured for amplifying signals, wherein the first detector has a first detector output operationally connected to the channel input and the second detector has a second detector output operationally connected to the channel input; and (f) a controller operationally connected to the channel output, the controller being configured for determining the range of the object based upon a time-of-flight of at least one of the pulses based upon output signals of the first detector and the second detector.

In accordance with an additional feature of the present invention, the shared electronic channel is also configured for filtering signals.

In accordance with an additional feature of the present invention, there is also provided a switch having a first switch input, a second switch input and a switch output, the first switch input being electrically connected to the switch output in a first operative position of the switch, the second switch input being electrically connected to the switch output in a second operative position of the switch, the first detector output being electrically connected to the first switch input, the second detector output being electrically connected to the second switch input, the switch output being electrically connected to the channel input.

In accordance with an additional feature of the present invention, the controller is further configured for shorting a connection within the second detector so as to render the second detector insensitive to the reflections of the pulses from less than a minimum range.

In accordance with an additional feature of the present invention, the controller is configured for shorting the connection within the second detector for at least 20 nanoseconds.

In accordance with an additional feature of the present invention, the switch is set to the first operative position prior to the source of laser radiation transmitting each of the pulses, the switch being set to the second operative position after the first detector detects each of the pulses.

### BRIEF DESCRIPTION OF THE DRAWINGS

The invention is herein described, by way of example only, with reference to the accompanying drawings, wherein:

FIG. 1 is schematic view of a rangefinder system that is constructed and operable in accordance with a preferred embodiment of the invention;

FIG. 2 is a schematic view of the electronics of the system of FIG. 1;

FIG. 3 is a flow chart showing the steps of operation of the system of FIG. 1; and

FIG. 4 is a graph showing the signal timing of the system of FIG. 1.

### DESCRIPTION OF THE PREFERRED EMBODIMENTS

The present invention is a rangefinder construction and method of operation thereof.

The principles and operation of a rangefinder according to the present invention may be better understood with reference to the drawings and the accompanying description.

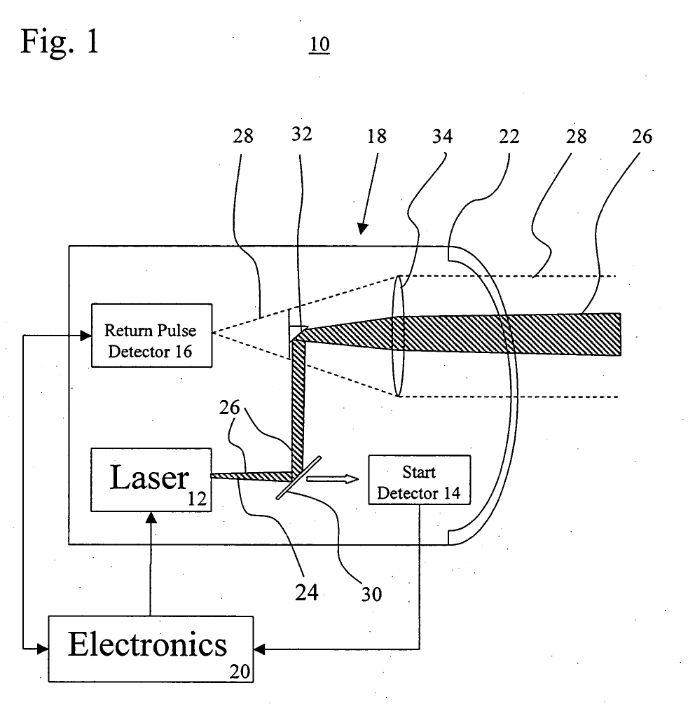

Reference is now made to FIG. 1, which is schematic view of a rangefinder system 10 for determining a range of an object (not shown) that is constructed and operable in accordance with a preferred embodiment of the invention. Rangefinder system 10 includes a source of laser radiation 12, a start detector 14, a return pulse detector 16, an optical arrangement 18, an electronic arrangement 20 and a window 22. Source of laser radiation 12 is typically configured for transmitting a plurality of pulses 24 of near-infrared laser radiation. Source of laser radiation 12 is defined herein to include a laser for producing pulses from in the range from visible light to infrared. Start detector 14 is typically a PIN photodiode. Return pulse detector 16 is typically an Avalanche Photodiode (APD).

Optical arrangement 18 is configured for directing pulses 24 along an outgoing path 26 and receiving pulses 24 reflected by the object along a return path 28. Optical arrangement 18 includes a partially-transparent mirror 30, a reflecting element 32 and a lens system 34. Lens system 34 is shown in FIG. 1 as a single lens. However, lens system 34 is typically a plurality of lenses. Partially-transparent mirror 30 is disposed in outgoing path 26 so that a majority of each pulse 24 is deflected by 90 degrees. A remaining portion of each pulse 24, not deflected by partially-transparent mirror 30, is transmitted through partially-transparent mirror 30 towards start detector 14. Therefore, start detector 14 is deployed to be responsive to pulses 24 travelling along outgoing path 26. The term “to be responsive” is defined herein to exclude detecting pulses 24 which have already exited rangefinder system 10 via window 22, but to include detecting reflections from partially reflecting optical components within rangefinder system 10 or transmission through such components within rangefinder system 10. Reflecting element 32 is disposed in return path 28 so that pulses 24 deflected by partially-transparent mirror 30 are deflected by reflecting element 32 through lens system 34 and out of rangefinder system 10 via window 22. Lens system 34 is disposed in both outgoing path 26 and return path 28 for diverging or converging pulses 24 of outgoing path 26 and return path 28, respectively.

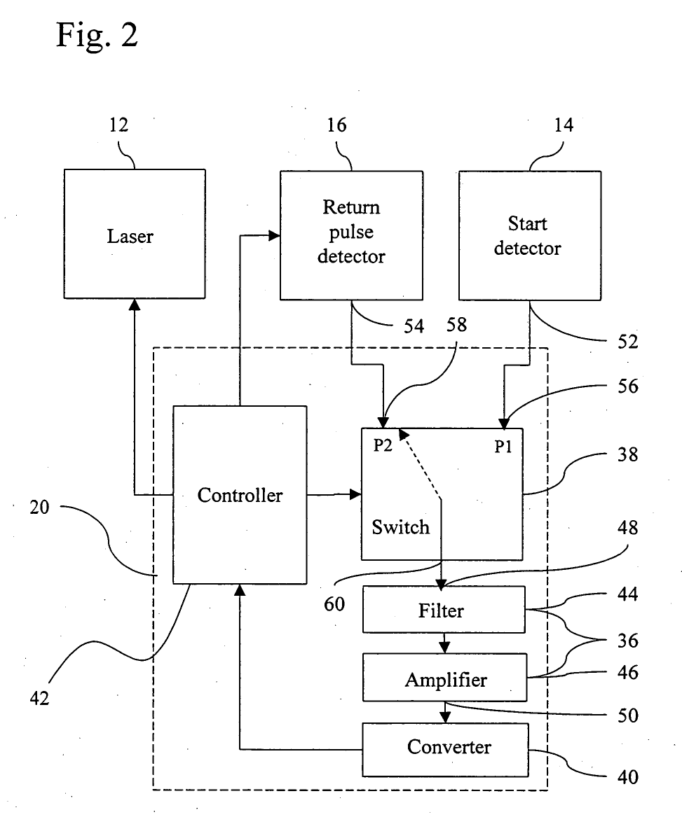

A part of each pulse 24 is reflected by window 22 back along return path 28 toward return pulse detector 16. This “back reflection” off of window 22, which can be up to 10% of the incident radiation, can be very problematic, potentially destroying, or at the very least saturating, return pulse detector 16. To overcome the problem of the “back reflection”, the present invention teaches rendering return pulse detector 16 insensitive to this “back reflection”, as will be described below with reference to FIG. 2.

Pulses 24 that are transmitted by window 22 continue to the object. Pulses 24 are reflected by the object back to rangefinder system 10 along return path 28 via window 22 and lens system 34. Return pulse detector 16 is deployed to receive and detect pulses 24 traveling along return path 28. It is seen that optical arrangement 18 defines a partially shared optical channel, shared by outgoing path 26 and return path 28 between reflecting element 32 and window 22.

Reflecting element 32 which is disposed in return path 28 is small enough so as not to disrupt too many pulses 24 travelling along return path 28.

Electronic arrangement 20 is configured for driving source of laser radiation 12 and processing signals from start detector 14 and return pulse detector 16. Electronic arrangement 20 is described in more detail with reference to FIG. 2, below.

Reference is now made to FIG. 2, which is a schematic view of electronic arrangement 20 of rangefinder system 10 of FIG. 1. Electronic arrangement 20 includes a shared electronic channel 36, a switch 38, a converter 40 and a controller 42.

Shared electronic channel 36 includes a filter 44 for filtering signals and an amplifier 46 for amplifying the filtered signals. Filter 44 is typically a 5 pole filter of 20 MHz per pole. Amplifier 46 is typically a variable gain digital amplifier. The gain of amplifier 46 is increased as a function of time after each pulse is transmitted by source of laser radiation 12. This is because the returned pulse intensity falls according to the inverse square of the distance to the reflecting object and it is preferable to maintain the amplified pulse amplitude in the optimal range for subsequent processing. In other words, if the output voltage of amplifier 46 has a range from 0 to 10 volts and you want to keep the pulse peak in the range of 4 to 8 volts to avoid reaching saturation, you need the amplification to be 4 times greater at 200 meters than for 100 meters because the distance has doubled and the received signal power has fallen off to 25%.

Shared electronic channel 36 is described as “shared” in that the same electronic components are used for filtering and amplifying the output signals of start detector 14 and return pulse detector 16. In other words, shared electronic channel 36 is a single electronic channel for filtering and amplifying output signals of start detector 14 and return pulse detector 16. Using a single channel increases the accuracy of the determination of the range of the object, as will be explained below. If two separate electronic channels are used, one for start detector 14 and one for return pulse detector 16, differences between the calibration and performance of each channel would create errors in the final calculated range of the object. This is mainly due to manufacturing differences and temperature differentials between the two channels. Therefore, by using a single electronic channel errors created by differences between channels do not exist and therefore the calculation of the range of the object is more accurate. Shared electronic channel 36 has a channel input 48 and a channel output 50. Start detector 14 has an output 52. Return pulse detector 16 has an output 54. Output 52 and output 54 are operationally connected to channel input 48. The term “operationally connected” is defined herein to include connection via a temporary connection such as switch 38.

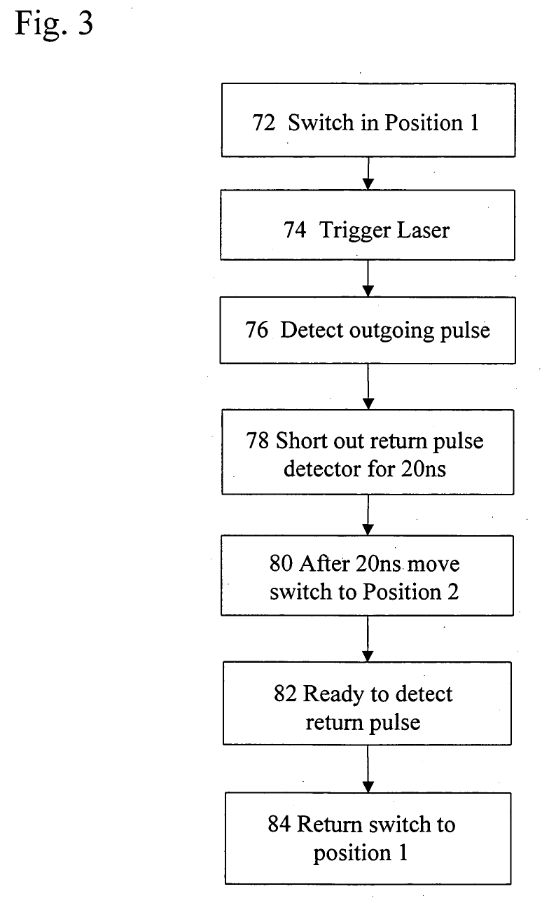

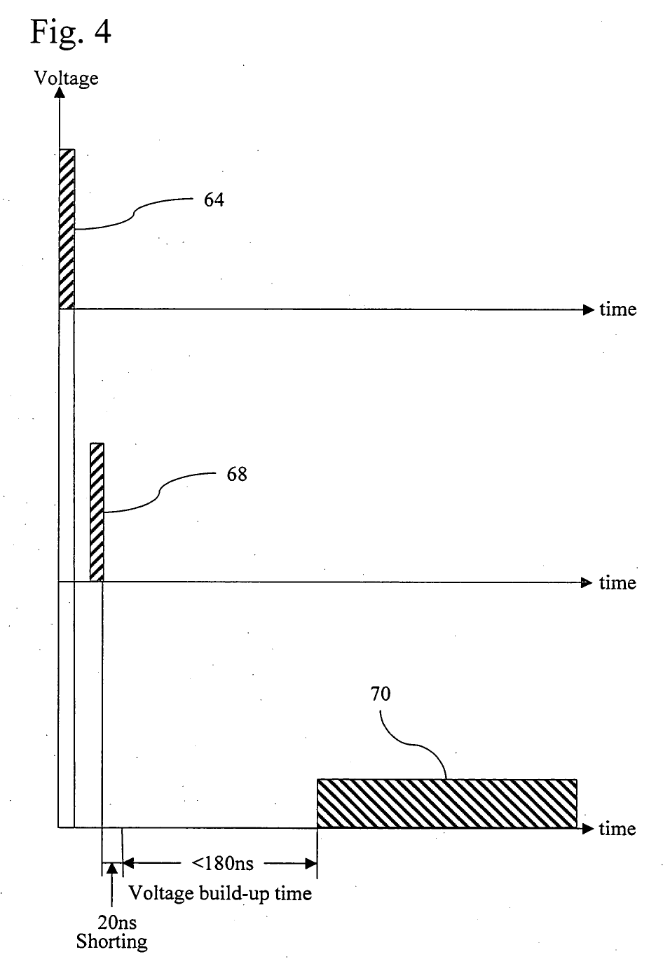

Switch 38 is an electronic switch controller by controller 42. The switching of switch 38 by controller 42 is described in more detail with reference to FIGS. 3 and 4. Switch 38 has a switch input 56, a switch input 58 and a switch output 60. Switch input 56 is electrically connected to switch output 60 in a first operative position, P1, of switch 38. Switch input 58 is electrically connected to switch output 60 in a second operative position, P2, of switch 38. As switch 38 is an electronic switch without moving parts, the term “electronically connected to switch output” is defined herein as allowing electrical current flow between the switch output and the operative switch input. Output 52 of start detector 14 is electrically connected to switch input 56 and output 54 of return pulse detector 16 is electrically connected to switch input 58. Therefore, switch 38 selectively routes the output signals of start detector 14 and return pulse detector 16 to channel input 48.

Converter 40 is operationally connected to channel output 50. Converter 40 receives the filtered and amplified outputs of start detector 14 and return pulse detector 16. Converter is configured for converting the output of amplifier 46 from an analogue signal to a digital signal.

Controller 42 is operationally connected to converter 40, switch 38, source of laser radiation 12 and return pulse detector 16. Controller 42 is configured for determining the range of the object based upon a time-of-flight of pulses 24 based upon output signals of start detector 14 and return pulse detector 16. Controller 42 knows whether the pulse it receives is from start detector 14 or return pulse detector 16 based upon the operative position of switch 38. Pulses 24 are distinguished from noise by defining a pulse as having an amplitude above a given threshold value.

Reference is now made to FIGS. 3 and 4. FIG. 3 is a flow chart showing the steps of operation of rangefinder system 10 of FIG. 1. FIG. 4 is a graph showing the signal timing of rangefinder system 10 of FIG. 1. When controller 42 determines that an output signal, associated with a returning pulse travelling along return path 28, drops below a predetermined value (in other words, the effective end of the pulse is detected) controller 42 performs two tasks. First, controller 42 switches switch 38 to operative position P1 (block 72), in preparation for shared electronic channel 36 to process an output signal 68 of start detector 14 in relation to detection of a new pulse transmitted by source of laser radiation 12. Second, after switch 38 is switched to operative position PI, controller 42 sends a trigger signal 64 to source of laser radiation 12 for triggering transmission of the new pulse (block 74). There is a short delay before source of laser radiation 12 produces the new pulse. This delay depends on the type of laser and other factors, such as the temperature of the laser.

Start detector 14 detects the new pulse as the new pulse travels along outgoing path 26 (block 76). When the beginning of the new pulse is detected by start detector 14, controller 42 renders return pulse detector 16 insensitive to reflections of the new pulse from less than a minimum range, by shorting a connection within return pulse detector 16. The term “less than a minimum range” is defined to include the possibility of excluding even reflections from outside rangefinder system 10, for example, but not limited to reflections from atmospheric aerosol. However, the “minimum range” can be chosen to exclude only reflections from window 22 inwards. Return pulse detector 16 is rendered insensitive to radiation almost immediately upon shorting. The shorting is performed for at least 20 nanoseconds, which corresponds to a distance traveled by the new pulse of approximately 6 meters (block 78). The shorting time is dependent upon the optical path from source of laser radiation 12 to window 22 and back to return pulse detector 16 taking into account the duration of the pulses. The shorting out can be longer to take into account reflection from atmospheric aerosol external to rangefinder system 10.

After the 20 nanosecond shorting period, controller 42 removes the shorting of return pulse detector 16 and switches switch 38 to operative position P2 (block 80), in preparation for shared electronic channel 36 to process an output signal 70 of return pulse detector 16 in relation to the new pulse returning along return path 28. After the shorting is removed, it takes between 150 nanoseconds and 180 nanoseconds for the voltage to build up across the return pulse detector 16 in order for return pulse detector 16 to start sensing (block 82).

When controller 42 determines that output signal 70 drops below a predetermined value or there has an elapse of time greater than a predetermined value, controller 42 then switches switch 38 to operative position P1 (block 84) and then triggers source of laser radiation 12 to fire another new pulse.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A range finder system for determining a range of an object, comprising:
(a) a source of laser radiation configured for transmitting a plurality of pulses;
(b) a first detector;
(c) a second detector;
(d) an optical arrangement configured for directing said pulses along an outgoing path and receiving said pulses reflected by the object along a return path, wherein:
(i) said first detector is deployed to be responsive to said pulses traveling along said outgoing path; and
(ii) said second detector is deployed to detect said pulses traveling along said return path; and
(e) a controller configured for:
(i) shorting a connection within said second detector so as to render said second detector insensitive to said reflections of said pulses from less than a minimum range; and
(ii) determining the range of the object based upon a time-of-flight of at least one of said pulses based upon output signals of said first detector and said second detector.

2. The system of claim 1, wherein said controller is configured for shorting said connection within said second detector for at least 20 nanoseconds.

3. The system of claim 1, further comprising a shared electronic channel having a channel input and a channel output, said shared electronic channel being configured for amplifying signals, wherein said first detector has a first detector output operationally connected to said channel input and said second detector has a second detector output operationally connected to said channel input, wherein said controller is operationally connected to said channel output.

4. The system of claim 3, wherein said shared electronic channel is also configured for filtering signals.

5. The system of claim 3, further comprising a switch having a first switch input, a second switch input and a switch output, said first switch input being electrically connected to said switch output in a first operative position of said switch, said second switch input being electrically connected to said switch output in a second operative position of said switch, said first detector output being electrically connected to said first switch input, said second detector output being electrically connected to said second switch input, said switch output being electrically connected to said channel input.

6. A range finder system for determining a range of an object, comprising:
(a) a source of laser radiation configured for transmitting a plurality of pulses;
(b) a first detector;
(c) a second detector;
(d) an optical arrangement configured for directing said pulses along an outgoing path and receiving said pulses reflected by the object along a return path, wherein:
(i) said first detector is deployed to be responsive to said pulses traveling along said outgoing path; and
(ii) said second detector is deployed to detect said pulses traveling along said return path;
(e) a shared electronic channel having a channel input and a channel output, said shared electronic channel being configured for amplifying signals, wherein said first detector has a first detector output operationally connected to said channel input and said second detector has a second detector output operationally connected to said channel input; and
(f) a controller operationally connected to said channel output, said controller being configured for determining the range of the object based upon a time-of-flight of at least one of said pulses based upon output signals of said first detector and said second detector.

7. The system of claim 6, wherein said shared electronic channel is also configured for filtering signals.

8. The system of claim 6, further comprising a switch having a first switch input, a second switch input and a switch output, said first switch input being electrically connected to said switch output in a first operative position of said switch, said second switch input being electrically connected to said switch output in a second operative position of said switch, said first detector output being electrically connected to said first switch input, said second detector output being electrically connected to said second switch input, said switch output being electrically connected to said channel input.

9. The system of claim 8, wherein said controller is further configured for shorting a connection within said second detector so as to render said second detector insensitive to said reflections of said pulses from less than a minimum range.

10. The system of claim 9, wherein said controller is configured for shorting said connection within said second detector for at least 20 nanoseconds.

11. The system of claim 9, wherein said switch is set to said first operative position prior to said source of laser radiation transmitting each of said pulses, said switch being set to said second operative position after said first detector detects each of said pulses.
